(19) United States
(12) Patent Application Publication
(10) Pub. No.: US 2011/0249121 A1
(43) Pub. Date: Oct. 13, 2011

(54) PERIMETER SECURITY SYSTEM USING ACTIVE ANALYSIS OF IMAGES REFLECTED BY A SET OF MIRRORS ONTO A VIDEO CAMERA

(76) Inventor: Bernard Taillade, Baillargues (FR)

(21) Appl. No.: 13/140,568

(22) PCT Filed: Dec. 4, 2009
(86) PCT No.: PCT/FR09/01388

§ 371 Date: Jun. 17, 2011

(30) Foreign Application Priority Data
Dec. 17, 2008 (FR) 0807084
Apr. 7, 2009 (FR) 0901688

(51) Int. Cl. H04N 7/18

(52) U.S. Cl. 348/153; 348/152; 348/E07.085

(57) ABSTRACT

A perimeter security system includes a video camera (1), an element (7) for transmitting or retransmitting a radiation lighting a scene observed by the camera (1), and a unit (4) for image analysis and processing and for driving the camera (1). The system is essentially characterized in that it includes, in order to multiply the number of shots while using a single camera (1), at least two mirrors (6, 61) partially inserted into the field of vision of the latter, each mirror having the same vertical orientation but a different horizontal orientation so that the portion of the image seen by the camera on each of the mirrors always represents the same scene relative to the lighting element (7).

### FIELD OF THE INVENTION

This invention relates to a perimeter security system using active analysis of images reflected by a set of mirrors onto a video camera.

### TECHNOLOGICAL BACKGROUND

The most common perimeter security systems are based on detecting breach of a sensitive area by means of a device detecting one or more infrared beams being cut. They generally consist of pair(s) of transmitter(s) and receiver(s) operating through a coding and/or synchronization of pulsed infrared beams between the transmitters and receivers. According to a first embodiment of said systems, the transmitter and receiver are placed facing each other on either side of the sensitive area to be monitored, which is traversed by the infrared beam or beams. The total screening by an object of the path of a beam, which corresponds to that of the lens located in front of the receiver, triggers an alarm if the beam, and therefore the infrared signal, is cut for a period greater than a generally parameterizable length of time.

Since the receiver consists of a photodiode, which is a single sensitive surface, the cutoff information is therefore binary concerning the reception or lack thereof of the infrared beam emitted by the transmitter. The number of beams, and thus cutoff information, is limited at most to the intercombination of one or more transmitters and receivers located on either side of the sensitive area of detection.

Moreover, this type of device requires wiring on both sides of the sensitive area and only provides very partial protection of the space between the emission and reception surfaces, in other words being limited to the surface of the receivers' lenses. According to a second embodiment of said systems, the transmitter and receiver are placed on the same side and are consequently associated with a reflector that sends the beams emitted by the transmitter back to the receiver. They generally have a very short range and their operation is only possible when the area of reflection, and therefore of detection, is a limited, single surface. In effect, since the receiver consists of a single sensitive area, using a large reflective surface only generates a lessening of reflectivity if the object crossing it is smaller and only screens part of the reflectors surface. In this case this results in it being impossible to detect definitively a partial but real cutoff of the beam. In a third embodiment of said systems, which uses the principle of detecting a sensitive area being breached by analyzing the variation of a camera's video image, and thus the variation of light reflected by the scene, the image sensor consists of hundreds of thousands of sensitive elements, which makes very precise analysis possible. There are however a large number of problems posed by this type of device, the first being that the system in question is passive and if an obstacle has been introduced into the scene while the system is stopped, then the fact that the sensitive area is breached behind the obstacle with respect to the camera becomes undetectable by the system. In addition, variations of light and movements of shadows make this equipment very sensitive to climatic conditions, and variations in the video signal not solely due to the passage of an object in the sensitive area.

According to a fourth embodiment of said systems, several cameras are used that offer the possibility of knowing very precisely, by triangulation, the height of the object and the location of the breach in the sensitive area between the cameras and the reflector or reflectors. Achieving such a result requires several cameras and a sophisticated image processing system since the received signals must be synchronized in order to simultaneously detect and measure a rapid variation in the field of these cameras. Patents EP1927957 and US2007/145272 are the closest prior art documents. They describe a system that comprises, basically:
a video camera whose sensitive sensor operates in both the visible and near-visible spectra;
a means designed to transmit or re-transmit, in the visible but also in the near-visible spectrum, a beam illuminating the scene viewed by the camera;
a unit for analyzing and processing images and controlling the camera designed to define one or more analysis frames of the image portion or portions containing the aforementioned illumination means and to analyze this portion of the image in order to detect any rapid variation of the video signal in the image area of the illumination means corresponding to the passage of an object or a person between the assembly comprising the camera and said means; the size of the screened image area varies according to the distance to the breach and according to the height of the object or person making the breach in the area masking said means.

### SUMMARY OF THE INVENTION

The problem this invention proposes to solve consists of replacing a set of cameras, whose signals must be synchronized in order to simultaneously detect and measure a rapid variation in the field of these cameras, by a set of mirrors for a lower cost price and requiring a much less sophisticated, since unique, image processing system.

The image portions are synchronized since they come from a single sensor, a single lens and a set of reflecting mirrors. Since the illumination means have a vertically elongated shape, this makes it possible to optimize the filling of the standard scene viewed by a 4/3-format camera in a variety of synchronous X/3 image formats, where X equals the number of mirrors.

The mirrors are partially inserted into the camera's field of view, each mirror having the same vertical orientation but a different horizontal orientation so that the image portion seen by the camera on each mirror always represents the scene with respect to the illumination means.

According to two embodiments of the invention, the means illuminating the scene viewed by the camera and sending the light beams back to it:
is a retro-reflector type of reflector, illuminated by at least one projector, able to generate the image portion having the greatest video signal amplitude;
is a projector, comprising a plurality of LED-type juxtaposed microprojectors, uniformly distributed over the entire height of said projector, emitting in the direction of said camera, able to generate the image portion having the greatest video signal amplitude.

In the case in which a retro-reflector type of reflector is used, the system controls the round-trip path of a controlled beam because it generates a quasi-saturated signal on a known, illuminated and controlled portion of the scene, namely the scene portion sent back by the reflector whose direction of light reflection is known and controlled. It allows very precise analysis of the surface of the image area of the reflector, the level of which is controlled (quasi-saturation) and the total or partial screening of which by an object generates a negative variation of the signal over a portion of the image sensor. The reflector can be large so that the sensitive area of detection is equally large. Once the breach has been definitively detected, the device can behave as a conventional video detection and visualization system to monitor changes in the breach within the camera's field of view. According to particular embodiments of the invention, the unit for analyzing and processing images and controlling the camera is designed to:
control the latter's electronic shutter so as to vary the sensors exposure time, and thus the value of the signal provided by said camera;
continuously analyze the video signal amplitude in each image portion containing the illumination means and control the electronic shutter so that the signal supplied is always less than and close to 100% of the maximum value of said video signal even when climatic conditions slowly vary the reflectors visibility conditions in rain, snow, or fog;
control the electronic shutter, after detecting a breach, such that the shutter speed is not calculated to obtain a signal close to 100% over the reflectors image area but is calculated to obtain an average value of 50% of the maximum signal over the image portions complementary to that containing the average (3, 7), in order to obtain a total image of the scene at the expense of a full saturation of portions of the image containing a reflector: such a solution makes it possible to view the change in the object or the person making the breach and switch on the video detection system included in the video analysis unit over the entire video image. According to other particular embodiments of the invention:
the surface of the reflector or reflectors may not be uniformly reflective so that the reflected light, and therefore the value of the signal, is not uniform over the entire height of the reflector, but varies slightly depending on the portion of it in question, this is so that it is not possible to simulate non-screening of the reflector by inserting a reflecting object of the same type: the variable lessening of reflection on the reflector of the system can be done by slight frosting on the reflector or by any other means with the same effect;
each camera or each reflector, or both, may be equipped with a band-pass filter whose transmitting wavelength is centered on the corresponding projectors wavelength so that each camera mostly perceives light beams from the corresponding projector and perceives little or none of the other beams having a different wavelength, this is in order to decrease the influence of sunlight or any other lighting device not forming part of the device: this selective filtering on the beams' wavelength allows the contrast between the reflectors image area and the rest of the image to be increased.

### PRESENTATION OF THE FIGURES

The characteristics and advantages of the invention will become clearer on reading the following detailed description of at least one preferred embodiment thereof, given as a non-limiting example and shown in drawings included in an appendix. In these drawings:

FIG. 1 is a schematic side view of a system comprising a camera, two mirrors, two projectors and a retro-reflector type of illumination means;

FIG. 2 is a schematic front view of the system according to FIG. 1, highlighting the position of the mirrors;

FIG. 3 is a video image seen by the camera on each of the mirrors;

FIG. 4 is a schematic side view of the system comprising a camera, two mirrors and an illumination means made of the juxtaposition of microprojectors;

FIG. 5 is a video image seen by the camera when the shutter is set to 100% of the maximum video signal in the area of the reflector;

FIG. 6 is a video image seen by the camera when the shutter is set to 50% of the maximum video signal of the entire image.

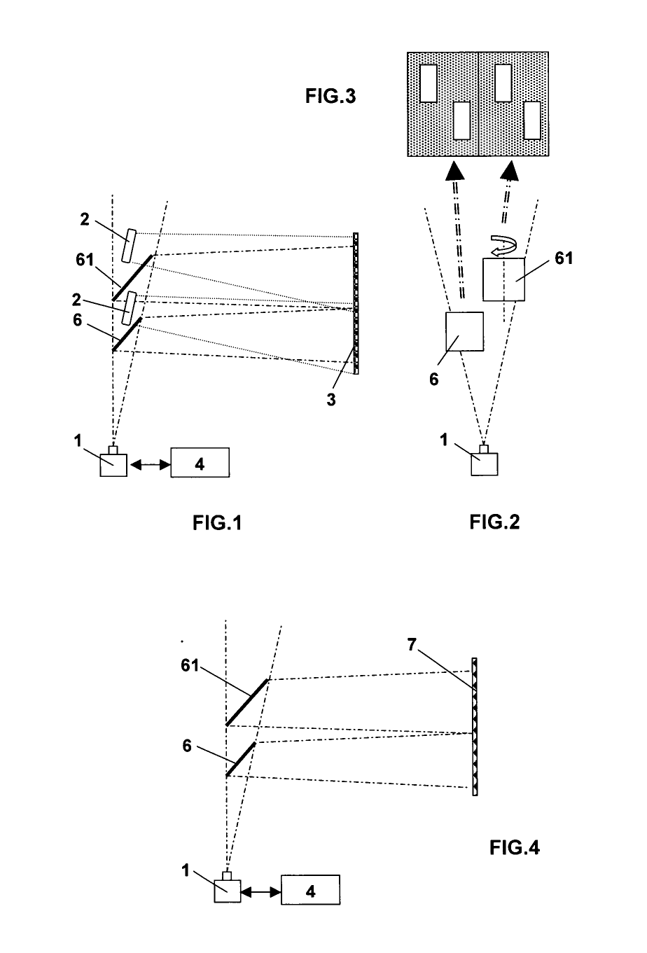

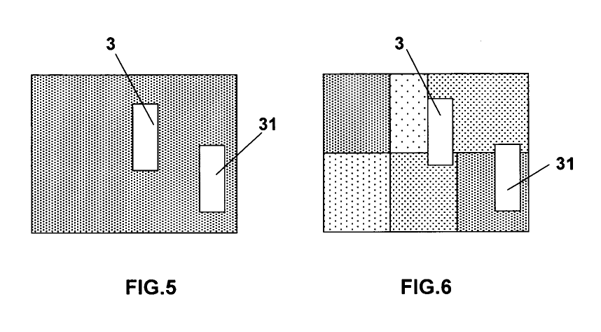

### DETAILED DESCRIPTION OF THE INVENTION

The system represented is of the type comprising:
a video camera (1) whose sensitive sensor operates in both the visible and near-visible spectra;
a means (3, 7) designed to transmit or re-transmit, in the visible but also in the near-visible spectrum, a beam illuminating the scene viewed by the camera;
a unit (4) for analyzing and processing images and controlling the camera (1) designed to define one or more analysis frames of the image portion or portions containing the illumination means (3, 7) and to analyze this portion of the image in order to detect any rapid variation of the video signal in the image area of said illumination means corresponding to the passage of an object or a person between the assembly comprising the camera (1) and said means (3, 7); the size of the screened image area varies according to the distance to the breach and according to the height of the object or person making the breach in the area masking the illumination means (3, 7). In order to multiply the number of shots while only using a single camera (1), it also comprises at least two mirrors (6, 61), partially inserted into the field of vision thereof, each mirror having the same vertical orientation but a different horizontal orientation so that the image portion seen by the camera on each mirror always represents the same scene with respect to the illumination means (3, 7).

According to two embodiments of the system:
the means able to illuminate the scene viewed by the camera (1) and send the light beams back to it, is a retro-reflector type of reflector (3), illuminated by at least one projector (2), able to generate the image portion having the greatest video signal amplitude;
the means able to illuminate the scene viewed by the camera (1) and send the light beams back to it is a projector (7), comprising a plurality of LED-type juxtaposed microprojectors, uniformly distributed over the entire height of said projector, able to generate the image portion having the greatest video signal amplitude.

The unit (4) for analyzing and processing images and controlling the camera (1) is designed to:
control the latter's electronic shutter so as to vary the sensors exposure time, and thus the value of the signal provided by said camera;
continuously analyze the video signal amplitude in each image portion containing the illumination means (3, 7) and control the electronic shutter of said camera so that the signal supplied is always less than and close to 100% of the maximum value of said video signal even when climatic conditions slowly vary the reflectors visibility conditions in rain, snow, or fog;
control the electronic shutter, after detecting a breach, such that the shutter speed is not calculated to obtain a signal close to 100% over the reflectors image area but is calculated to obtain an average value of 50% of the maximum signal over the image portions complementary to that containing the average (3, 7).

The surface of the means (3, 7) is not uniformly emitting or reflective so that the transmitted light, and therefore the value of the signal, is not uniform over its entire height, but varies slightly depending on the portion of it in question. The camera (1) or the means (3, 7) is equipped with a band-pass filter whose transmitting wavelength is centered on the wavelength emitted or re-emitted by the means (3, 7) so that said camera mostly perceives light beams from said means (3, 7) and perceives little or none of the other beams having a different wavelength. The system may comprise an additional processing and control unit, which is designed to receive the signal from the camera (1), to interact with the unit (4) for analyzing and processing images and control and to control the switching on and off of the projector (2, 7) synchronously with the video signal, the cyclic switching on/off ratio of each said means corresponding to the sensitization time of the associated sensor, so that the light output is greater during the sensitization of the sensor and zero the rest of the time.

Said additional unit for processing and controlling the periodic switching on and off of the projector (2, 7), is designed to generate a cycle of switching on and switching off the lighting that makes it possible to take several alternating images with and without lighting so as to ascertain, by differential measurement between the two images, the proportion of light of said projector (2, 7) and to control the lighting external to the system, such as sunlight or artificial lighting, that may illuminate the detection area. The unit (4) for analyzing and processing images and controlling the camera (1) is designed to analyze the variation of the portion of the image containing the illumination means (3, 7) according to the luminance of the video signal, hue and color saturation when the system operates in the visible light spectrum, so as to take into account the variation in hue or color saturation that can be caused by the object that is screening all or part of the reflector.

According to a particular configuration of the invention, the system comprises, positioned face-to-face on each side of the area to be monitored, at least two cameras (1), at least two illumination means (3, 7) and at least two sets of at least two mirrors (6, 61), in order to have a system in which the area of low coverage near each camera is compensated for by the opposite camera and in which the overlapping of the fields of view makes it possible to obtain, by triangulation, the distance to the breach by comparing the highest screening point on each of the image portions containing said illumination means (3, 7).

Of course, experts will be able to realize the invention as described and represented by applying and adapting known methods without needing to have them described or represented.

They may also provide other variations without departing from the scope of the invention, which is determined by the content of the claims.

1-12. (canceled)

13. A perimeter security system, that comprises:
a video camera comprising a sensor, said video camera having an optical axis defining an axis known as a vertical axis;
an illumination means designed to transmit or re-transmit a beam illuminating the scene viewed by the camera;
a unit for analyzing and processing images and controlling the camera designed to detect any rapid variation of the video signal, in the image area representing said illumination means, corresponding to the passage of an object or a person between the assembly comprising the camera and said illumination means, masking the illumination means;
said security system comprising, in order to multiply the number of shots while only using a single camera, at least two mirrors, inserted into a portion of the camera's field of vision; each mirror forms the same angle with the vertical axis and has a different orientation around the vertical axis so that the image portion seen by the camera on each mirror always represents the illumination means, the illumination means being able to generate the image portion having the greatest video signal amplitude.

14. A security system according to claim 13, wherein the angle formed between the axis perpendicular to the mirrors and the optical axis of the camera is substantially 45°.

15. A security system according to claim 13, wherein each mirror has a horizontal orientation around the vertical axis designed so that the image portion seen by the camera on each mirror always represents the same scene with respect to the illumination means.

16. A security system according to claim 13, wherein the illumination means is a retro-reflector type of reflector, illuminated by at least one projector.

17. A security system according to claim 13, wherein the illumination means is a projector, comprising a plurality of LED-type juxtaposed microprojectors, uniformly distributed over the entire height of said projector.

18. A security system according to claim 13, wherein the unit for analyzing and processing images and controlling the camera is designed to control the camera's electronic shutter so as to vary the sensor's exposure time.

19. A security system according to claim 13, wherein the unit for analyzing and processing images and controlling the camera is designed to continuously analyze the video signal amplitude in each image portion representing the illumination means and control the electronic shutter of said camera so that the signal supplied is always less than and close to 100% of the maximum value of said video signal.

20. A security system according to claim 13, wherein the unit for analyzing and processing images and controlling the camera is designed to control the camera's electronic shutter, after detecting the passage of an object or a person between the assembly comprising the camera and the illumination means masking the illumination means, such that the shutter speed makes it possible to obtain an average value of 50% of the maximum signal over the image portions complementary to the image portions representing the illumination means.

21. A security system according to claim 13, wherein the surface of the illumination means is not uniformly emitting or reflective so that the light transmitted to the sensor, and therefore the value of the signal, is not uniform over the entire height of the image portion representing the illumination means, but varies depending on the portion in question of the illumination means.

22. A security system according to claim 13, wherein the camera is equipped with a band-pass filter whose transmitting wavelength is centered on the wavelength emitted or re-emitted by the illumination means so that said camera mostly perceives light beams from said illumination means and perceives little or none of the other beams having a different wavelength.

23. A security system according to claim 13, which comprises an additional processing and control unit, which is designed to receive the signal from the camera, to interact with the unit for analyzing and processing images and controlling the camera and to control the switching on and off of the illumination means synchronously with the video signal, the cyclic switching on/off ratio of each said illumination means corresponding to the sensitization time of the associated sensor, so that the light output is greater during the sensitization of the sensor and zero the rest of the time.

24. A security system according to claim 13, which comprises an additional processing and control unit, which is designed to receive the signal from the camera, to interact with the unit for analyzing and processing images and controlling the camera and to control the switching on and off of the illumination means to generate a cycle of switching on and switching off the lighting that makes it possible to take several alternating images with and without lighting so as to ascertain, by differential measurement between the two images, the proportion of light of the illumination means and to control the lighting external to the system, such as sunlight or artificial lighting, that may illuminate the detection area.

25. A security system according to claim 13, wherein the unit for analyzing and processing images and controlling the camera is designed to analyze the variation of the portion of the image containing the illumination means according to the luminance of the video signal, hue and color saturation when the system operates in the visible light spectrum, so as to take into account the variation in hue or color saturation that can be caused by the object that is screening all or part of the reflector.

26. A security system according to claim 13, which comprises, positioned face-to-face on each side of the area to be monitored, at least two cameras, at least two illumination means and at least two sets of at least two mirrors, in order to have a system in which the area of low coverage near each camera is compensated for by the opposite camera and in which the overlapping of the fields of view makes it possible to obtain, by triangulation, the distance to the breach by comparing the highest screening point on each of the image portions containing said illumination means.

27. A security method, that comprises:
a step of capturing, with a camera, an image comprising a plurality of portions representing, by means of mirrors, a single illumination means and
a step of analyzing said image to detect any rapid variation of the video signal in each image area representing said illumination means, corresponding to the passage of an object or a person between the assembly comprising the camera and the illumination means, masking the illumination means.
